(19) United States
(12) Patent Application Publication
(10) Pub. No.: US 2020/0225792 A1
(43) Pub. Date: Jul. 16, 2020

(54) DISPLAY DEVICE

(71) Applicant: WUHAN CHINA STAR OPTOELECTRONICS TECHNOLOGY CO., LTD., Wuhan (CN)

(72) Inventor: Li HU, Wuhan (CN)

(21) Appl. No.: 16/335,252

(22) PCT Filed: Feb. 25, 2019
(86) PCT No.: PCT/CN2019/076006

§ 371 Date: Mar. 21, 2019

(30) Foreign Application Priority Data
Dec. 24, 2018 (CN) 201811580311.4

(51) Int. Cl. G06F 3/041; H04M 1/02

(52) U.S. Cl. CPC G06F 3/0412; G06F 2203/04102; H04M 1/0268

(57) ABSTRACT

The present invention discloses a display device, including at least one bending area and non-bending areas connected to two sides of each bending area, and each bending area having a bending center line; and a substrate. In a corresponding part of each bending area, the substrate is disposed with several strip-shaped channels, and a length direction of each strip-shaped channel is parallel to the bending center line. The present invention has the following beneficial effect: The display device in the present invention uses a conductive film material having higher flexibility, in replacement of a material commonly used by a substrate and a touch electrode in the prior art, strip-shaped channels are provided on the substrate, and during bending, the strip-shaped channels are folded to reduce stress applied by the display device to the bending area, thereby reducing a risk of a fracture of the touch electrode due to the stress.

### FIELD OF INVENTION

The present invention relates to the field of display technologies, and in particular, to a display device.

### BACKGROUND OF INVENTION

With the rapid development of flexible display screens, there are increasing requirements on bendable electronic products. For example, for a smartphone, when the smartphone is bent, the smartphone has a size of a mobile phone, and when the smartphone is unbent, the smartphone has a size of a table computer, so that the smartphone is convenient to carry and has more diversified functions.

To bend a whole mobile phone, a display screen is required to be bendable, and a touchscreen is also required to be bendable. However, a conductive material mainly used by current touchscreens is indium tin oxide (ITO), ITO has poor bending performance and is unsuitable for manufacturing a bendable touchscreen. Additionally, a base material for current touchscreens is mainly glass or polyethylene terephthalate (PET) that has poor bending performance and cannot meet a requirement for a base material of a bendable touchscreen.

### Technical Problem

In the prior art, when a bendable display screen is bent, a fracture of a touch electrode is caused due to concentration of stress.

### SUMMARY OF INVENTION

The present invention provides a display device, including at least one bending area and non-bending areas connected to two sides of each bending area, and each bending area has a bending center line; and a substrate. In a corresponding part of each bending area, the substrate is disposed with several strip-shaped channels, and a length direction of each strip-shaped channel is parallel to the bending center line.

Further, the several strip-shaped channels are spaced and arranged in parallel, to form a serration structure.

Further, a material used by the substrate is polyimide.

Further, the display device further includes a panel, disposed on one side of the substrate back facing the strip-shaped channels; and the panel is disposed with several touch areas distributed in an array.

Further, each touch area has two first electrode areas and two second electrode areas. The two first electrode areas are disposed opposite to each other. The two second electrode areas are disposed opposite to each other. A connection line between centers of the two first electrode areas disposed opposite to each other perpendicularly intersects a connection line between centers of the two second electrode areas disposed opposite to each other. In the bending area, an intersecting position at which the connection line between the centers of the first electrode areas intersects the connection line between the centers of the second electrode areas corresponds to the strip-shaped channel.

Further, the display device further includes a conductive film, disposed on the panel and corresponding to the touch area.

Further, the conductive film includes a plurality of first conductive layers, correspondingly connected to the first electrode areas of the touch areas respectively, and in each touch area, gap is defined between the two first conductive layers correspondingly connected to the two first electrode areas, and the gap corresponds to the intersecting position; a plurality of second conductive layers, each second conductive layer correspondingly extending from one first electrode area of each touch area to the other first electrode area, and the second conductive layer passes through the gap; and a plurality of bridging conductive layers, each bridged between the first conductive layers corresponding to the two first electrode areas of each touch area.

Further, in the bending area, the second conductive layer is parallel to the bending center line.

Further, the display device further includes an insulation layer, covering the conductive film. The insulation layer is disposed with vias. The bridging conductive layers are disposed on the insulation layer and are connected to the first conductive layers through the vias.

Further, a material of the conductive film includes at least one of a nanometer sized silver filament, a metal mesh, graphene, or a carbon nanotube.

Beneficial Effect

The display device in the present invention uses a conductive film material having higher flexibility, in replacement of a material commonly used by a substrate and a touch electrode in the prior art, strip-shaped channels are provided on the substrate, and during bending, the strip-shaped channels are folded to reduce stress applied by the display device to the bending area, thereby reducing a risk of a fracture of the touch electrode due to the stress.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a planar view of a display device according to Embodiment 1.

FIG. 2 is a side view of a bending area according to Embodiment 1.

FIG. 3 is a bending view of the display device according to Embodiment 1.

FIG. 4 is a side view of a substrate according to Embodiment 1.

FIG. 5 is a side view of a substrate according to Embodiment 2.

FIG. 6 is a bending view of the display device according to Embodiment 2.

FIG. 7 is a schematic partial view of the display device according to Embodiment 1.

In the drawings:

10: Display device

110: Panel 120: Substrate

121: Bending area 122: Non-bending area 1211: Bending center line

1210: Strip-shaped channel

130: Conductive film 140: Insulation layer 114: Metal conductive area

1141: First metal conductive area 1142: Second metal conductive area

1410: Via

1110: Touch area

1111: First electrode area 1112 Second electrode area

1310: First conductive layer 1320: Second conductive layer

1330: Bridging conductive layer

### DETAILED DESCRIPTION OF PREFERRED EMBODIMENTS

Preferred embodiments of the present invention are described in detail below with reference to the accompanying drawings in this specification, to completely describe technical content of the present invention to a person skilled in the art, to prove, by using an example, that the present invention can be implemented, so that the technical content disclosed in the present invention is clearer, and it is more easy for a person skilled in the art to understand how to implement the present invention. However, the present invention may be embodied by using many different forms of embodiments, the protection scope of the present invention are not limited to the embodiments mentioned in this specification, and descriptions of the following embodiments are not intended to limit the scope of the present invention.

Terms about directions mentioned in the present invention, such as “upper”, “lower”, “front”, “rear”, “left”, “right”, “in”, “out”, and “side surface” merely refer to directions in the accompanying drawings. The direction terms used in this specification are intended to explain and describe the present invention, but are not intended to limit the protection scope of the present invention.

In the accompanying drawings, components having a same structure are represented by a same numeral, and components having similar structures or functions are represented by similar numerals. In addition, for ease of understanding and description, a size and a thickness of each component shown in the accompanying drawings are arbitrarily shown, and the size and the thickness of each component are not limited in the present invention.

When some components are described to be “on” another component, the component may be directly disposed on the another component; or there may be an intermediate component, the component is disposed on the intermediate component, and the intermediate component is disposed on the another component. When a component is described to be “installed on” or “connected to” another component, it may be understood that they are directly “installed” or “connected”, or a component is “installed on” or “connected to” another component by using an intermediate component.

### Embodiment 1

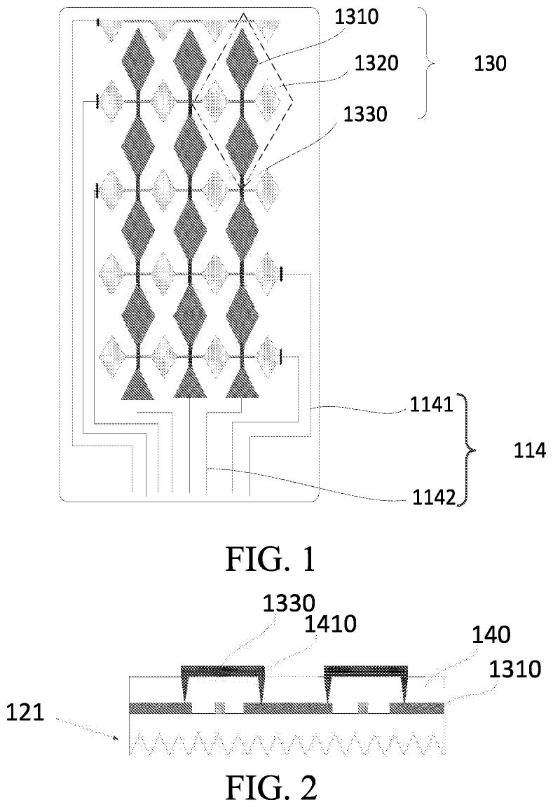

As shown in FIG. 1 and FIG. 2, in the present embodiment, a display device 10 in the present invention includes a panel 110, a substrate 120, a plurality of strip-shaped channels 1210, a conductive film 130, and an insulation layer 140.

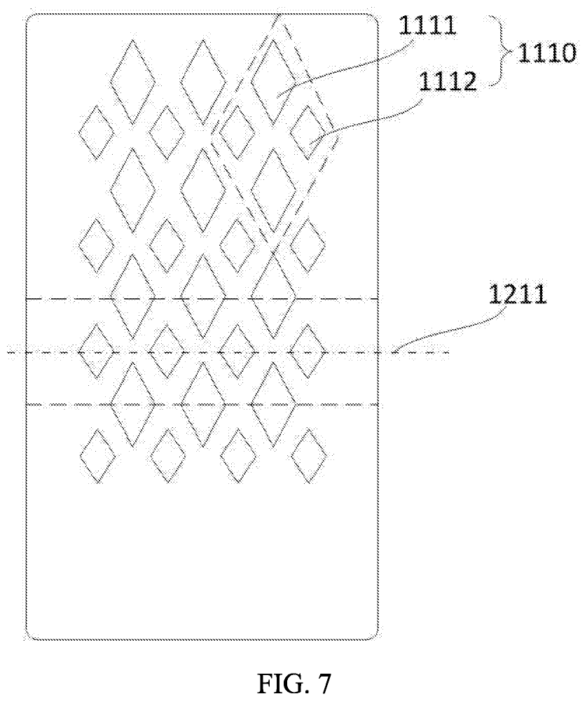

As shown in FIG. 7, the substrate 120 includes a bending area 121 and non-bending areas 122 connected to two sides of each bending area 121. Each bending area 121 has a bending center line 1211.

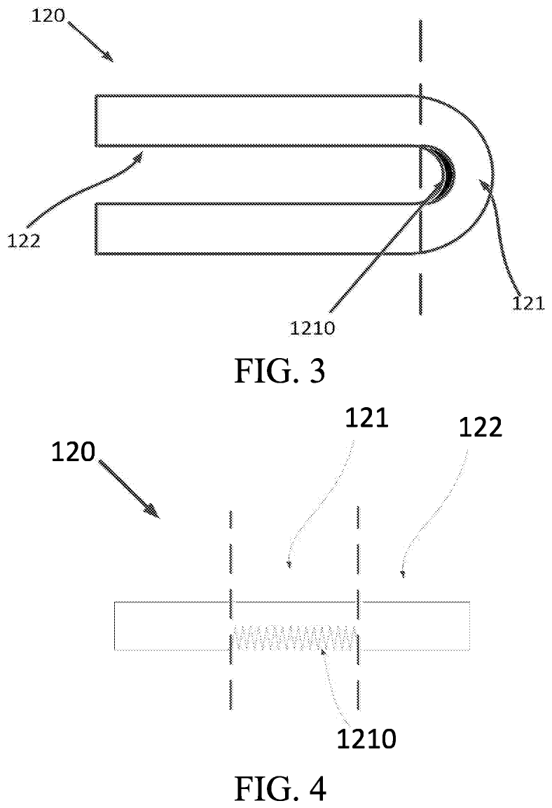

As shown in FIG. 3 and FIG. 4, each time the display device 10 is bent or unbent, compressive stress and tensile stress are applied to the bending area 121 of the display device 10. For example, when the display device 10 is bent, as shown in FIG. 3, the compressive stress is applied to the front side of the bending area 121 of the display device 10, and the tensile stress is applied to the back side of the bending area 121 of the display device 10. Because stress is applied to the bending area 121 of the display device 10 in two different directions, a fracture of the conductive film 130 is easily caused. To solve the problem, in the present invention, the strip-shaped channels 1210 are provided on the bending area 121. The strip-shaped channel 1210 is parallel to a bending direction of the substrate 120 and the bending center line 1211. The strip-shaped channels 1210 are spaced and arranged in parallel, to form a serration structure concave in the substrate 120. As shown in FIG. 4, the strip-shaped channels 1210 have a serration shape and a bottom of the strip-shaped channel is spiky. Therefore, when the display device 10 is bent, the strip-shaped channels 1210 are folded, and the compressive stress and the tensile stress applied to the bending area 121 are greatly reduced, and the conductive film 130 corresponding to the bending area 121 uses a flexible material such as a nanometer sized silver filament, a metal mesh, graphene, or a carbon nanotube, so that a fracture of the touch unit is not easily caused when the touch unit is bent.

The panel 110 is disposed on one side of the substrate 120 back facing the strip-shaped channels 1210, and the panel 110 is disposed with several touch areas 1110 distributed in an array. Each touch area 1110 has two first electrode areas 1111 and two second electrode areas 1112. The two first electrode areas 1111 are disposed opposite to each other. The two second electrode areas 1112 are disposed opposite to each other. A connection line between centers of the two first electrode areas 1111 disposed opposite to each other perpendicularly intersects a connection line between centers of the two second electrode areas 1112 disposed opposite to each other. The first electrode area 1111 and the second electrode area 1112 are a transmitting end and a receiving end of each other, to receive and transmit an external signal.

The conductive film 130 is disposed on the panel 110 and corresponds to the touch area 1110. The conductive film 130 includes a plurality of first conductive layers 1310, where the first conductive layer 1310 is correspondingly connected to the first electrode area 1111 of each touch area 1110; and in each touch area 1110, a gap is defined between the two first conductive layers 1310 correspondingly connected to the two first electrode areas 1111, and the gap corresponds to the intersecting position; a plurality of second conductive layers 1320, each second conductive layer 1320 correspondingly extending from one first electrode area 1111 of each touch area 1110 to the other first electrode area 1111, where the second conductive layer 1320 passes through the gap; and a plurality of bridging conductive layers 1330, each disposed on the insulation layer 140, and bridged between the first conductive layers 1310 corresponding to the two first electrode areas 1111 of each touch area 1110.

The insulation layer 140 covers the conductive film 130, the insulation layer 140 is disposed with vias 1410, and the bridging conductive layers 1330 are in communication with the first conductive layers 1310 through the vias 1410.

The metal conductive area 114 is arranged on an outer side of the touch area 1110. The metal conductive area 114 includes a plurality of first metal conductive areas 1141 and a plurality of second metal conductive areas 1142. The first metal conductive areas 1141 are sequentially connected to outer sides of the first conductive layers 1310 close to the touch areas 1110 and are converged below the panel 110. The second metal conductive areas 1142 are sequentially connected to the second conductive layers 1320 and are converged below the panel 110.

### Embodiment 2

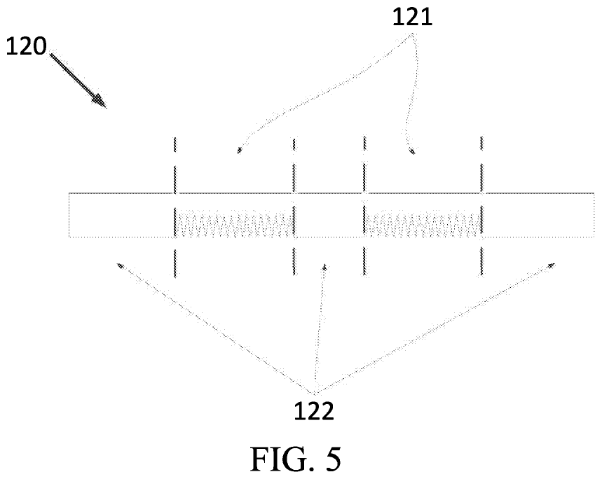

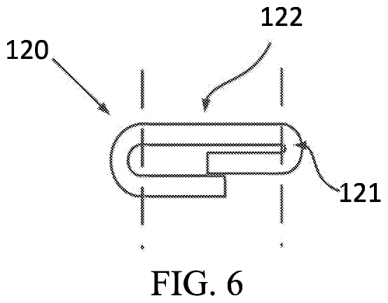

As shown in FIG. 5 and FIG. 6, the present embodiment and Embodiment 1 have a vaguely similar structure, and a difference lies in that, in the present embodiment, the substrate 120 in the present invention includes two bending areas 121 and non-bending areas 122 outside the bending areas 121. When the display device 10 is bent, the non-bending areas 122 at the two sides of the bending area 121 are bent toward one side of the substrate 120 away from the panel 110.

The terminal and the device provided in the present invention are described in detail above. It should be understood that, the exemplary implementations in this specification should be considered as merely for description, and are used to help understand the method and core ideas of the present invention rather than limit the present invention. Descriptions of a feature or an aspect in each exemplary implementation should be generally considered as a similar feature or aspect applicable to another exemplary embodiment. Although the present invention is described with reference to the exemplary embodiments, a person skilled in the art may be advised to make various changes and modifications. The present invention is intended to cover these changes and modifications falling within the scope of the appended claims.

The above descriptions are merely preferred embodiments of the present invention, but are not intended to limit the present invention. Any modification, equivalent replacement, and improvement made without departing from the spirit and principle of the present invention shall fall within the protection scope of the present invention.

What is claimed is:

1. A display device, comprising
at least one bending area and non-bending areas connected to two sides of each of the at least one bending area, wherein each of the at least one bending area has a bending center line; and
a substrate, wherein in a corresponding part of each of the at least one bending area, the substrate is disposed with several strip-shaped channels, and a length direction of each strip-shaped channel is parallel to the bending center line.

2. The display device according to claim 1, wherein
the several strip-shaped channels are spaced and arranged in parallel, to form a serration structure.

3. The display device according to claim 1, wherein
a material used by the substrate is polyimide.

4. The display device according to claim 1, further comprising:
a panel, disposed on one side of the substrate back facing the strip-shaped channels, wherein
the panel is disposed with several touch areas distributed in an array.

5. The display device according to claim 4, wherein
each touch area has two first electrode areas and two second electrode areas; the two first electrode areas are disposed opposite to each other; the two second electrode areas are disposed opposite to each other; and a connection line between centers of the two first electrode areas disposed opposite to each other perpendicularly intersects a connection line between centers of the two second electrode areas disposed opposite to each other; and
in the at least one bending area, an intersecting position at which the connection line between the centers of the first electrode areas intersects the connection line between the centers of the second electrode areas corresponds to the strip-shaped channel.

6. The display device according to claim 5, further comprising
a conductive film, disposed on the panel and corresponding to the touch area.

7. The display device according to claim 6, wherein
the conductive film comprises:
a plurality of first conductive layers, correspondingly connected to the first electrode areas of the touch areas respectively, wherein
in each touch area, a gap is defined the two first conductive layers correspondingly connected to the two first electrode areas, and the gap corresponds to the intersecting position;
a plurality of second conductive layers, each second conductive layer correspondingly extending from one first electrode area of each touch area to the other first electrode area, wherein the second conductive layer passes through the gap; and
a plurality of bridging conductive layers, each bridged between the first conductive layers corresponding to the two first electrode areas of each touch area.

8. The display device according to claim 7, wherein in the at least one bending area, the second conductive layer is parallel to the bending center line.

9. The display device according to claim 7, further comprising:
an insulation layer, covering the conductive film, wherein the insulation layer is disposed with vias; and
the bridging conductive layers are disposed on the insulation layer and are connected to the first conductive layer through the vias.

10. The display device according to claim 7, wherein a material of the conductive film comprises at least one of a nanometer sized silver filament, a metal mesh, graphene, or a carbon nanotube.
